(19) United States
(12) Patent Application Publication
(10) Pub. No.: US 2006/0226054 A1
(43) Pub. Date: Oct. 12, 2006

(54) Disc screen assembly

(76) Inventor: Harry Richard Bishop JR., Pass Christian, MS (US)

Correspondence Address: PATTERSON & SHERIDAN, L.L.P., 3040 POST OAK BOULEVARD, SUITE 1500, HOUSTON, TX, 77056, US

(21) Appl. No.: 11/095,012

(22) Filed: Mar. 31, 2005

(51) Int. Cl. B07B 13/00

(52) U.S. Cl. 209/667

(57) ABSTRACT

An apparatus for a disc screen assembly and a method of making a screen disc is disclosed. The disc screen assembly includes a plurality of classifying discs and a plurality of spacers detachably mounted on the outer perimeter of a tubular shaft. The spacers may be made of a metallic or a polymeric material. The disc screen assembly may span the length or width of a screening bed in one unitary assembly. The spacers are abrasion resistant and communicate sufficient resiliency to the classifying discs.

### BACKGROUND OF THE INVENTION

1. Field of the Invention

Embodiments of the invention generally relate to disc screens used for classifying or screening discrete materials. Specifically, the invention relates to a disc screen assembly and a method of making a disc screen assembly with a unitary or one piece body and improved spacers.

2. Description of the Related Art

In industries such as waste management, gravel sales, and paper manufacturing, disc screens are used to separate or classify discrete raw materials. A plurality of disc screens, each having a rotating shaft with a longitudinal series of concentric screen discs, are placed in a spaced-apart, parallel orientation to each other, allowing the respective screen discs to interdigitate to form a screening bed. Raw material is then supplied above the screening bed. As the disc screens rotate, spaces between the respective interdigitating screen discs permit only a specific material size or smaller to be carried by gravity through the screening bed. Larger material will be driven in a common direction to a removal apparatus by the common rotation of the individual disc screens. Thus, the screening bed is useful as a classifying device where the end product is a large or small sized material.

In the past, many forms of disc screens have been employed and have presented many challenges to an operator. Disc screens that are rigidly mounted to the rotating shaft tend to allow slightly oversized material to become lodged between screen discs, thereby causing a jam in the screening bed or damage to the screen disc or an adjacent screen disc. An attempt to alleviate this challenge was the addition of resilient plastic spacers between non-rigid screen discs. This accommodated limited flexure of individual screen discs, thus allowing slightly oversized material to pass through. While this approach substantively solved jamming, the plastic spacers tended to wear quickly due to the abrasive nature of the raw materials to be classified, causing materials of unspecified size to pass through the screening bed if the worn spacers are not repaired or replaced.

Typically, each screening bed is made of a plurality of disc screens oriented serially and parallel. To replace even one worn spacer or a worn disc on one disc screen, the screening bed is shut down and the disc screen removed from the bed. Each screen disc on the removed disc screen may then be removed to replace any worn spacers and then is reassembled. Once reassembled, the disc screen may then be reattached to the screening bed. Typically, there is not only one spacer on one disc screen affected, but a plurality of spacers needing repair or replacement, which increases the time the screening bed is down for disassembly and reassembly of a plurality of disc screens and reassembly of the disc screens into the screening bed.

Another challenge presented with the prior art disc screens is that they are modular, e.g., 6-8 screen discs mounted on a disc screen shaft. These disc screens are then longitudinally connected to each other or serially mounted on a bearing shaft that forms a length of serially connected disc screens suitable for a length or width of a screening bed. While this approach would be beneficial if one of the modular disc screens would need refurbishing, this is not the typical case. The raw material to be screened affects the screening bed on a global basis, not specific disc screens, causing removal of a plurality of these modular disc screens from the screening bed. Thus, considerable downtime is experienced during the disassembly and reassembly of the modular sections from the screening beds and disassembly and reassembly of a plurality of disc screens.

Therefore, there is a need for a unitary or one piece disc screen assembly having a spacer that exhibits sufficient resiliency and superior wear resistance from the raw materials classified by the apparatus, thereby minimizing replacement spacer cost and screening bed downtime.

### SUMMARY OF THE INVENTION

The present invention generally provides a disc screen shaft assembly having a tubular shaft with an outer perimeter, where a portion of the tubular shaft forms a screen area. The disc screen assembly further comprises a plurality of classifying discs and a plurality of spacers, wherein the plurality of classifying discs and the plurality of spacers are detachably mounted on the outer perimeter in the screen area. The spacers may be metallic or made of a polymeric material. The disc screen assembly further comprises a plurality of guide rods in communication with each of the plurality of classifying discs and each of the plurality of spacers, and at least two compressive caps mounted peripherally of the screen area in communication with the tubular shaft and at least one of the plurality of classifying discs.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an isometric view of a screening bed apparatus.

FIG. 2 is a schematic side view of an embodiment of a disc screen assembly.

FIG. 3 is a detail view of a classifying disc.

FIG. 4A is a side detail view of a spacer of the present invention.

FIG. 4B is an end detail view of a spacer of the present invention.

### DETAILED DESCRIPTION

Embodiments of the present invention provides an assembly for use in an apparatus for separating, classifying, or screening materials according to the material size.

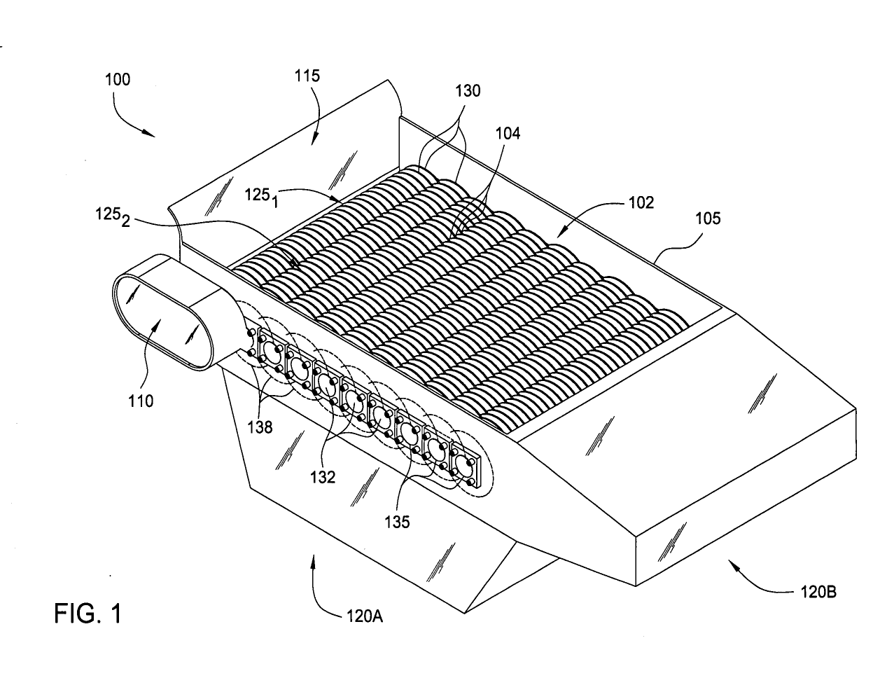

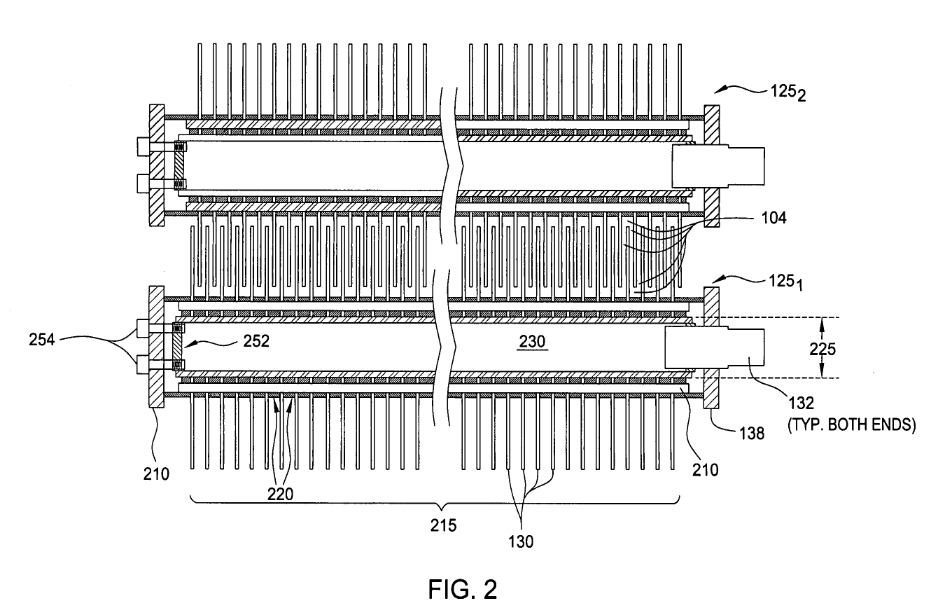

FIG. 1 is an isometric view of a screening apparatus 100 that illustrates the present invention. The apparatus 100 has a body 105 that defines a screening bed 102. The body 105 has an input or feed area 115, and two classified material output areas 120A and 120B. The screening bed 102 is made of a plurality of spaced apart parallel interdigitating disc screen assemblies 125_{N} that are connected to the body 105 via shafts 132 and bearing blocks 135. For example, the disc screen assembly 125₁ is spaced apart and longitudinally parallel from disc screen assembly 125₂. Each disc screen assembly 125_{N} comprises a plurality of screen discs or classifying discs 130. The plurality of classifying discs 130 from disc screen assembly 125₁ are spaced to mesh or interdigitate with the classifying discs 130 from disc screen assembly 125₂, thereby forming an opening or classifying space 104 between two adjacent classifying discs 130 (better seen in FIG. 2). This classifying space 104 between the interdigitating classifying discs 130 should be uniform throughout the entire screening bed 102, thereby allowing ingress of a specific material size or smaller into the classifying space 104.

In operation, raw material is introduced adjacent a feed area 115 above the screening bed 102. A drive mechanism 110 may be energized or previously energized causing the disc screen assemblies 125_{N} to rotate via continuous belts or chains in communication with gears or sprockets 138 connected to the disc screen assemblies 125_{N}. The drive mechanism 110 communicates force to the sprockets 138 and is adapted to allow common unidirectional rotation to the disc screen assemblies 125_{N}. The movement of the disc screen assemblies 125_{N} serve to agitate the raw material on the screening bed 102, thereby sifting the material and allowing material of a specified size to be carried by gravity through the classifying spaces 104 to a small material output area 120A. A material larger than the specified size will not enter the classifying spaces 104 and will travel on the upper surface of the screening bed 102 via a direction provided by the common rotation of the disc screen assemblies 125_{N} to a large material output area 120B. Thus, a raw material has been separated into two distinct material sizes.

FIG. 2 is a schematic side view of one embodiment of a disc screen assembly 125₁ typical of the disc screen assemblies 125_{N} shown in FIG. 1. The disc screen assembly 125₁ comprises a tubular shaft 230 with an outer perimeter 225. A plurality of classifying discs 130 are mounted on the outer perimeter 225 with a plurality of spacers 220 therebetween. As will be explained in greater detail below, the classifying discs 130 and the spacers 220 form a screen area 215 and are aligned longitudinally by at least one alignment member such as a plurality of guide rods 260. The classifying discs 130 and the spacers 220 are then held substantially static by compressive end caps 210 connected by bolts or screws 254 to suitable threaded holes in shaft end caps 252 connected to the tubular shaft 230. Although typical to both longitudinal ends of the tubular shaft 230, a circular shaft 132 is shown only on one end to provide clarity.

The disc screen assembly 125₁ in one embodiment may comprise a longitudinal dimension to span the length or width of a screening bed 102. In another embodiment, the longitudinal dimension may be less than the length or width of a screening bed 102, requiring two or more disc screen assemblies 125_{N} to be serially and longitudinally connected to span a length or width of a screening bed 102.

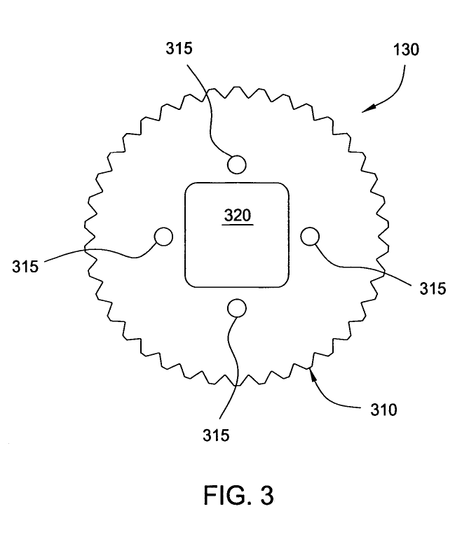

FIG. 3 is a detail view of a classifying disc 130 having an inner area 320, a serrated outer diameter 310 and guide rod passages 315. The inner area 320 is sized greater than or equal to the outer perimeter 225 of the tubular shaft 230. Preferably, the inner area 320 is sized to allow the classifying disc 130 to detachably mount on the outer perimeter 225 of the tubular shaft 230 with ease. The guide rod passages 315 are sized to surround the guide rods 260, which assist in alignment of the classifying disc 130 and the spacers 220. The classifying disc 130 may have a serrated outer diameter 310 to aid in movement of the raw material in and on the screening bed 102.

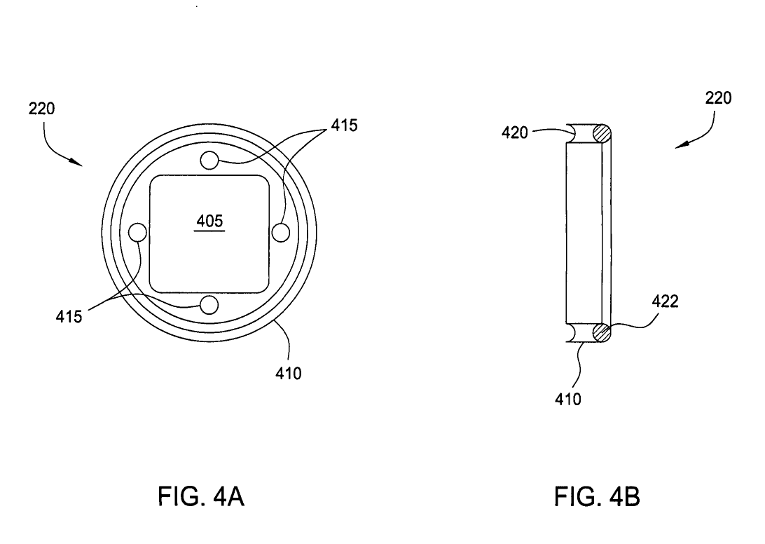

FIG. 4A is a side detail view of a spacer 220 of the present invention having an inner area 405, an outer diameter 410 and guide rod passages 415. The inner area 405 is sized greater than or equal to the outer perimeter 225 of the tubular shaft 230. Preferably, the inner area 405 is sized to allow the spacer 220 to detachably mount on the outer perimeter 225 of the tubular shaft 230 with ease. The at least one passage 415 is sized to surround the at least one guide rod 260, which assists in alignment of the classifying discs 130 and the spacers 220.

FIG. 4B is an end detail view of a spacer 220 of the present invention having an outer diameter 410. Adjacent the outer diameter 410 is an O-ring groove 420 adapted to receive an O-ring 422. When installed on the shaft 230, the O-ring 422 will be disposed between the spacer 220 and the classifying disc 130. The O-ring may be a suitable polymer material and is adapted to provide resiliency and flexibility between the spacer 220 and the classifying disc 130.

In one embodiment, the spacer 220 is non-metallic, made of a polymer material such as a urethane that exhibits a hardness and abrasion resistance capable of withstanding abrasion from the raw materials. For example, the polymer material used may have a durometer in a range of about 60 Shore A to about 140 Shore A, for example, between about 85 Shore A to about 110 Shore A. In another embodiment, the spacer 220 is made of a metallic material, such as mild steel, abrasion resistant (AR) steel, hardened steel, stainless steel, copper, titanium, aluminum, or combinations thereof, which exhibit a high wear resistance to the raw materials.

A method of manufacturing an improved disc screen assembly will now be detailed. The method includes the steps of providing a tubular member with a shaft extending from the tubular member on both ends, where a longitudinal dimension of the tubular member and the shafts extending therefrom are configured to attach to and span a width of a screening bed. A plurality of classifying discs will be mounted thereon, with a plurality of spacers therebetween. The classifying discs and the spacers may then be aligned and mounted with at least one guide rod in communication with a passage integral with the spacers and classifying discs. The plurality of classifying discs, with the spacers therebetween, and the at least one guide rod will form a screen area on the tubular member. The screen area may then be secured on both ends with compression end caps that are in communication with at least one of the classifying discs and the tubular member via bolts or screws. The compression end caps include a sprocket for connection to a chain or belt and are configured to translate rotational motion to the disc screen assembly when installed in the screening bed.

While the foregoing is directed to embodiments of the present invention, other and further embodiments of the invention may be devised without departing from the basic scope thereof, and the scope thereof is determined by the claims that follow.

1. A disc screen shaft assembly, comprising:
a tubular shaft with an outer perimeter, a portion of the tubular shaft forming a screen area;
a plurality of classifying discs; and
a plurality of spacers, wherein the plurality of classifying discs and the plurality of spacers are detachably mounted on the outer perimeter in the screen area.

2. The shaft assembly of claim 1, further comprising:
a plurality of guide rods in communication with each of the plurality of classifying discs and each of the plurality of spacers; and
at least two compressive caps mounted peripherally of the screen area in communication with the tubular shaft and at least one of the plurality of classifying discs.

3. The shaft assembly of claim 1, wherein the spacer has an outer diameter and an inner area greater than the outer perimeter of the tubular shaft.

4. The shaft assembly of claim 3, wherein the spacer has at least one O-ring groove adjacent the outer diameter.

5. The shaft assembly of claim 3, wherein the spacer further comprises:
at least one O-ring disposed in the at least one O-ring groove.

6. The shaft assembly of claim 3, wherein the spacer comprises a polymer material.

7. The shaft assembly of claim 3, wherein the spacer comprises an aluminum material.

8. The shaft assembly of claim 1, wherein the tubular shaft spans a length or a width of a screening bed.

9. A disc screen shaft assembly, comprising:
a tubular shaft with an outer perimeter, a portion of the tubular shaft forming a screen area;
a plurality of classifying discs;
a plurality of spacers, wherein the plurality of classifying discs and the plurality of spacers are detachably mounted on the outer perimeter in the screen area;
a plurality of guide rods in communication with each of the plurality of classifying discs and each of the plurality of spacers; and
at least two compressive caps mounted peripherally of the screen area in communication with the tubular shaft and at least one of the plurality of classifying discs.

10. The shaft assembly of claim 9, wherein the spacer has an outer diameter an inner area greater than the outer perimeter of the tubular shaft.

11. The shaft assembly of claim 10, wherein the spacer has at least one O-ring groove adjacent the outer diameter.

12. The shaft assembly of claim 10, wherein the spacer further comprises:
at least one O-ring disposed in the at least one O-ring groove.

13. The shaft assembly of claim 10, wherein the spacer comprises one of an aluminum material or a polymer material.

14. The shaft assembly of claim 9, wherein the tubular shaft spans a length or a width of a screening bed.

15. A disc screen shaft assembly, comprising:
a tubular shaft with an outer perimeter, a portion of the tubular shaft forming a screen area;
a plurality of classifying discs;
a plurality of spacers, comprising:
an inner area and an outer diameter;
at least one o-ring groove adjacent the outer diameter; and
at least one o-ring disposed in the at least one o-ring groove, wherein the plurality of classifying discs and the plurality of spacers are detachably mounted on the outer perimeter of the screen area;
a plurality of guide rods in communication with each of the plurality of classifying discs and each of the plurality of spacers; and
at least two compressive caps mounted peripherally of the screen area in communication with the tubular shaft and at least one of the plurality of classifying discs.

16. The shaft assembly of claim 15, wherein the spacer has an outer diameter and an inner area greater than the outer perimeter of the tubular shaft.

17. The shaft assembly of claim 16, wherein the spacer comprises an aluminum material.

18. The shaft assembly of claim 15, wherein the tubular shaft spans a length or a width of a screening bed.

19. A method of manufacturing an improved disc screen assembly for a screening bed, comprising:
providing a tubular member having two longitudinal ends;
providing on each end an extending shaft member adapted to be installed in a screening bed apparatus, the tubular member and the extending shafts having a longitudinal dimension to span a width of the screening bed;
forming a screen area having two ends on an outer perimeter of the tubular member, the screen area comprising a plurality of classifying discs with a spacer therebetween and aligned with at least one guide rod in communication with the screen area; and
compressing the ends of the screen area.
